(19) United States
(12) Patent Application Publication
(10) Pub. No.: US 2023/0056580 A1
(43) Pub. Date: Feb. 23, 2023

(54) ADJUSTABLE BUCKLE LOCK ASSEMBLY

(71) Applicant: ABA LOCKS INTERNATIONAL CO., LTD., New Taipei City (TW)

(72) Inventor: Miko LEE, NEW TAIPEI CITY (TW)

(21) Appl. No.: 17/404,339

(22) Filed: Aug. 17, 2021

(51) Int. Cl. E05C 19/14; E05B 65/00; E05B 65/52

(52) U.S. Cl. CPC E05C 19/14; E05B 65/0042; E05B 65/5284

(57) ABSTRACT

An adjustable buckle lock has a hook unit, a fixing unit, a wrench unit, an adjustment assembly, and a buckling ring unit. The hook unit can be securely mounted on a first locked object, and the fixing unit can be securely mounted on a second locked object. A pivotal end of the wrench unit is pivotally mounted on the fixing unit. The adjustment assembly is mounted on the wrench unit, and the buckling ring unit is pivotally mounted on the adjustment assembly and selectively hooks on the hook unit. With the moving of the buckling ring unit controlled by the adjustment assembly, the distance between the buckling ring unit and the hook unit is changed, and thus the pulling force for the buckling ring unit hooking on the buckling ring unit is adjusted, which ensures the first locked object and the second locked object are sealed together by a suitable force.

### BACKGROUND OF THE INVENTION

### 1. Field of the Invention

The present invention relates to a buckling means, especially to a buckle lock that is adapted to a refrigerator or a freezer.

### 2. Description of the Prior Arts

To seal a jar or a box, a buckle lock is mounted on a main body and a lid body of the sealed jar or the sealed box. Moreover, if a cooling device, e.g., a refrigerator or a freezer, is not sealed completely, cooled gas may keep leaking from the cooling device. To maintain the temperature in the cooling device, the compressor of the cooling device has to keep operating, which not only shortens the useful lifetime, but also consumes huge amount of energy. Therefore, some refrigerators and freezers may have buckle locks for sealing the main body and the lid body and preventing the cooled gas leaking.

Please refer to FIG. 8. A conventional buckle lock includes a hook unit 91, a fixing unit 92, a wrench unit 93, and a buckling ring unit 94. The hook unit 91 is securely mounted on a lid body of a sealed jar, a sealed box, a refrigerator, a freezer, etc. The fixing unit 92 is securely mounted on a main body of the sealed jar, the sealed box, the refrigerator, the freezer, etc. The wrench unit 93 is pivotally mounted on the fixing unit 92 and the buckling ring unit 94 is pivotally mounted on the wrench unit 93, and the buckling ring unit 94 is controlled by the wrench unit 93 and thus the buckling ring unit 94 is selectively hooked on the hook unit 91 or separated from the hook unit 91.

In the aforesaid sealed jar, sealed box, refrigerator, freezer, etc., the sealing state between the main body and the lid body totally depends on the buckle lock. However, a force for sealing provided by the conventional buckle lock is determined when the buckle lock is mounted. In other words, after the hook unit 91 is securely mounted on the lid body and the fixing unit 92 is securely mounted on the main body, a distance between the hook unit 91 and the fixing unit 92 is determined, and thus a tightening force resulting from the buckling ring unit 94 hooked on the hook unit 91 is determined, too. If the locations of the hook unit 91 and the fixing unit 92 are not ideal, the conventional buckle lock may not be capable of providing sufficient tightening force and thus the jar or the device cannot be sealed exactly.

To overcome the shortcomings, the present invention provides an adjustable buckle lock to mitigate or obviate the aforementioned problems.

### SUMMARY OF THE INVENTION

The main objective of the present invention is to provide an adjustable buckle lock that is configured to be mounted on a first locked object and a second locked object, and thereby secures the first locked object and the second locked object. Further, a tightening force provided by the adjustable buckle lock can be adjusted, which ensures the first locked object and the second locked object are sealed together by a suitable force.

The adjustable buckle lock has a hook unit, a fixing unit, a wrench unit, an adjustment assembly, and a buckling ring unit. The hook unit is configured to be securely mounted on the first locked object. The fixing unit is configured to be securely mounted on the second locked object. The wrench unit has two end and the two ends of the wrench unit defined as a pivotal end and an operation end. The pivotal end is pivotally mounted on the fixing unit. The operation end is opposite the pivotal end. The adjustment assembly is mounted on the wrench unit. The buckling ring unit is pivotally mounted on the adjustment assembly and selectively engaged with the hook unit. The adjustment assembly is capable of controlling a distance between the buckling ring unit and the hook unit.

As a result, the moving of the buckling ring unit is controlled by the adjustment assembly, and the distance between the buckling ring unit and the hook unit is adjusted correspondingly. Thus the pulling force for the buckling ring unit hooking on the buckling ring unit is adjusted as well, which ensures the first locked object and the second locked object are sealed together by a suitable force.

Other objectives, advantages and novel features of the invention will become more apparent from the following detailed description when taken in conjunction with the accompanying drawings.

### BRIEF DESCRIPTION OF THE DRAWINGS

FIG. 1 is an operational schematic view of an adjustable buckle lock in accordance with the present invention, showing the adjustable buckle lock mounted on the first locked object and the second locked object;

FIG. 2 is a perspective view of the adjustable buckle lock in FIG. 1;

FIG. 3 is a side view of the adjustable buckle lock in FIG. 1;

FIG. 4 is an exploded view of the adjustable buckle lock in FIG. 1;

FIG. 5 is a perspective view of a buckling ring unit of the adjustment assembly of the adjustable buckle lock in FIG. 1;

FIG. 6 is a rear view of a buckling ring unit of the adjustment assembly of the adjustable buckle lock in FIG. 1;

FIG. 7 is a side view of a buckling ring unit of the adjustment assembly of the adjustable buckle lock in FIG. 1; and

FIG. 8 is a perspective view of a conventional buckle lock.

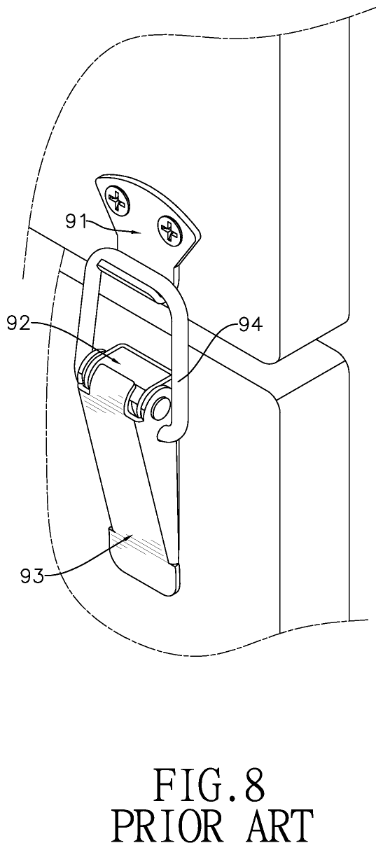

### DETAILED DESCRIPTION OF THE PREFERRED EMBODIMENTS

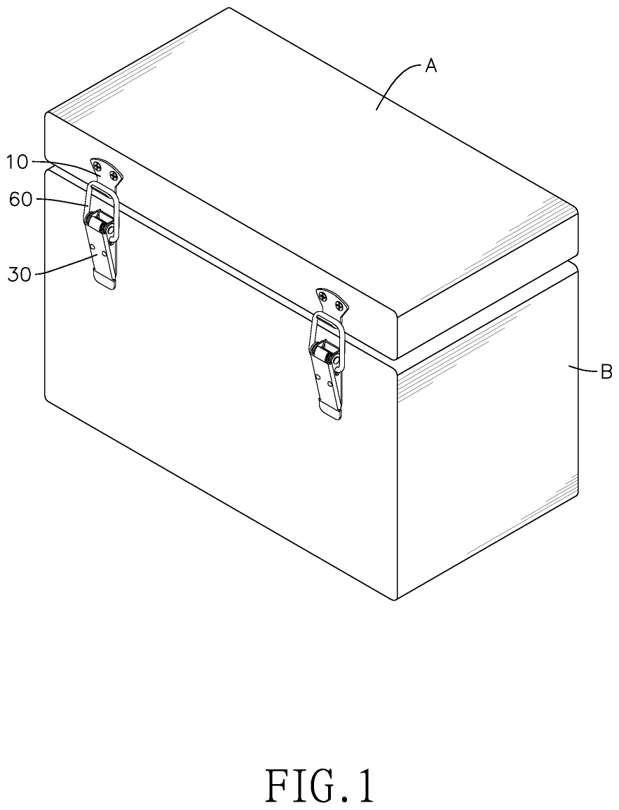

With reference to FIG. 1, an adjustable buckle lock in accordance with the present invention is provided. The adjustable buckle lock is configured to be mounted on a first locked object A and a second locked object B and then secure the first locked object A and the second locked object B. For example, the first locked object A may be a lid body of a freezer and the second locked object B may be a main body of the freezer. Or, the first locked object A may be a lid body of a sealed jar and the second locked object B may be a main body of the sealed jar. Alternatively, the first locked object A may be a main body and the second locked object B may be a lid body.

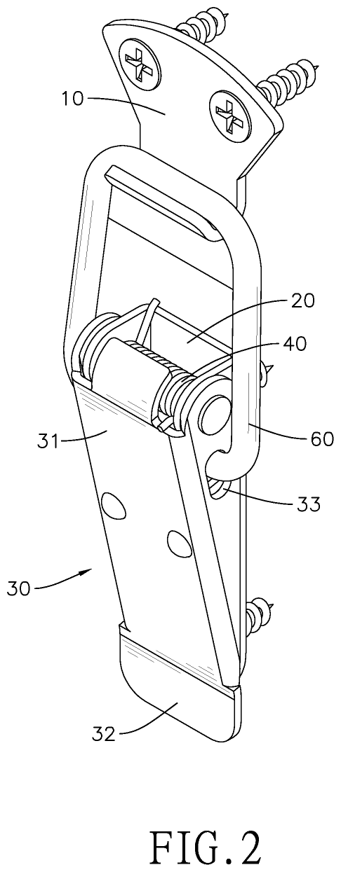

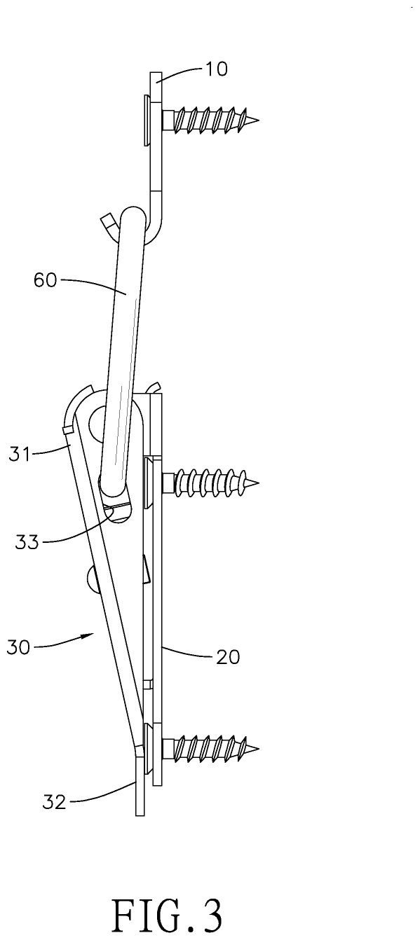

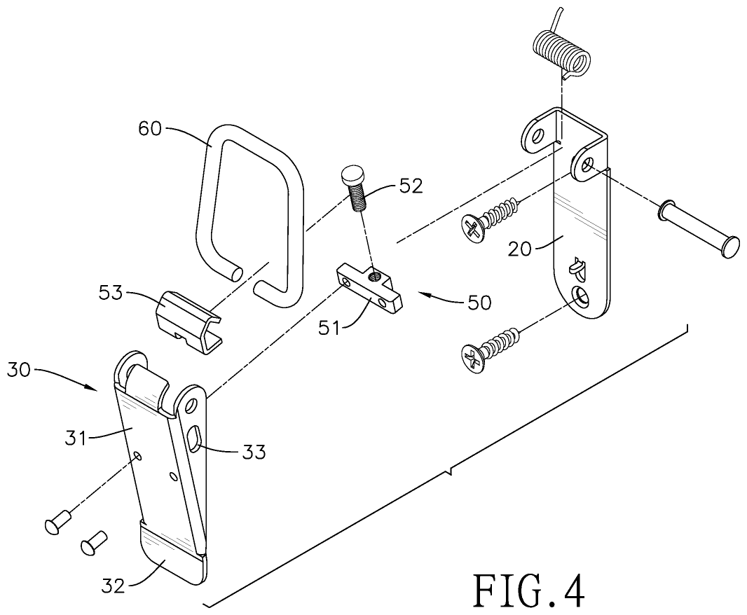

Then please also refer to FIG. 2 to FIG. 4. In this embodiment, the adjustable buckle lock may comprise a hook unit 10, a fixing unit 20, a wrench unit 30, an elastic unit 40, an adjustment assembly 50, and a buckling ring unit 60. The hook unit 10 is configured to be securely mounted on the first locked object A and the fixing unit 20 is configured to be securely mounted on the second locked object B.

Two ends of the wrench unit 30 are defined as a pivotal end 31 and an operation end 32, respectively. The operation end 32 and the pivotal end 31 are opposite to each other. The pivotal end 31 is pivotally mounted on the fixing unit 20. One end of the elastic unit 40 is securely mounted on the wrench unit 30 and another end of the elastic unit 40 is securely mounted on the fixing unit 20, which forces the wrench unit 30 to rotate toward the fixing unit 20. In this embodiment, the elastic unit 40 may be a torsion spring which is sleeved on a pivotal axle of the fixing unit 20 with respect to the wrench unit 30. The adjustment assembly 50 is mounted on the wrench unit 30 and the buckling ring unit 60 is pivotally mounted on the adjustment assembly 50. Therefore, the adjustment assembly 50 is capable of controlling a distance between the buckling ring unit 60 and the hook unit 10.

The buckling ring unit 60 selectively hooks on the hook unit 10. When the buckling ring unit 60 does not hook on the hook unit 10, the first locked object A can be detached from the second locked object B or rotated with respect to the second locked object B. When the buckling ring unit 60 hooks on the hook unit 10, the first locked object A and the second locked object B are pulled and sealed by the adjustable buckle lock. With the adjustment assembly 50 controlling the buckling ring unit 60 in location, the distance between the buckling ring unit 60 and the hook unit 10 can be adjusted, and thereby the pulling force which pulls the buckling ring unit 60 to hook the hook unit 10 is adjusted, which ensures the first locked object A and the second locked object B are sealed together by a suitable force.

In this embodiment, the wrench unit 30 comprises two side walls and two elongation grooves 33. The two side walls are parallel to and spaced apart from each other and the adjustment assembly 50 is located between the two side walls. The two elongation grooves 33 are formed on the two side walls respectively. An extending direction of each one of the elongation grooves 33 is parallel to a moving direction as the buckling ring unit 60 is moved by the adjustment assembly 50. However, the structures are not limited thereto. In other words, the wrench unit 30 may not have said two side walls, or the adjustment assembly 50 may not be located between the two side walls.

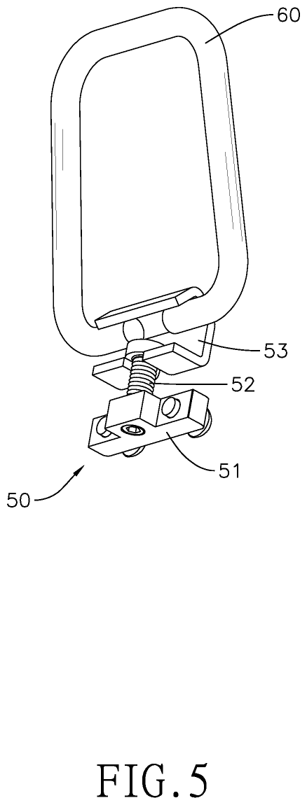

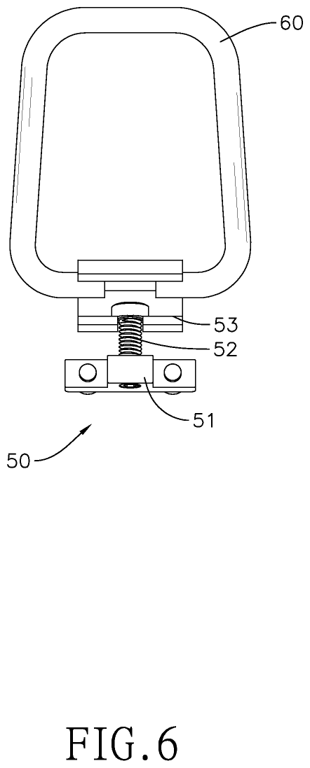

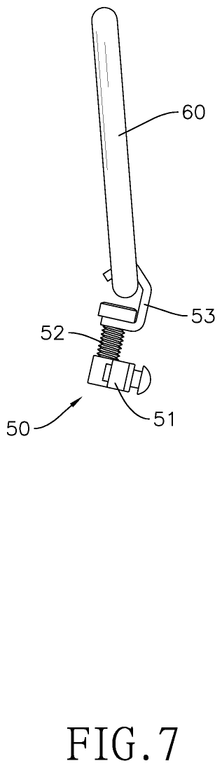

Then please refer to FIG. 5 to FIG. 7. The adjustment assembly 50 may comprise a fixed base 51, a movable component 52, and a pivoting base 53. The fixed base 51 is securely mounted on the wrench unit 30, the movable component 52 is movably mounted on the fixed base 51, and the pivoting base 53 is securely mounted on the movable component 52. The buckling ring unit 60 is pivotally mounted on the pivoting base 53, and when the movable component 52 is moved, the movable component 52 can drive the pivoting base 53 and the buckling ring unit 60 to move, which controls the distance between the buckling ring unit 60 and the hook unit 10.

In this embodiment, the fixed base 51 may be in a T-shape. Two arm portions of the T-shape are securely mounted on the wrench unit 30 and the movable component 52 is movably mounted on a leg portion of the T-shape. However, a shape of the fixed base 51 is not limited thereto.

In this embodiment, the pivoting base 53 may be tubular. An axial direction of the pivoting base 53 is perpendicular to a moving direction of the movable component 52. The buckling ring unit 60 is rotatably mounted through the pivoting base 53. Precisely, a portion of the buckling ring unit 60 is mounted in the pivoting base 53, and a length direction of said portion of the buckling ring unit 60 is parallel to the axial direction of the pivoting base 53, and thus the buckling ring unit 60 can pivot about the axial direction of the pivoting base 53 to hook on the hook unit 10 or separate from the hook unit 10. A sectional area of the pivoting base 53 may be C-shaped and said sectional area is perpendicular to the axial direction of the pivoting base 53. An opening of the C-shape is oriented away from the wrench unit 30, which prevents the buckling ring unit 60 detaching from the pivoting base 53. In another embodiment, the structure of the pivoting base 53 is not limited thereto.

In this embodiment, the movable component 52 may be a screw, a bolt, etc. Therefore, the movable component 52 may comprise a thread and be screwed on the fixed base 51, and thereby, via rotating with respect to the fixed base 51, the movable component 52 is capable of driving the pivoting base 53 and the buckling ring unit 60 to move. Precisely, the movable component 52 may comprise a threaded portion and a head portion. The threaded portion is threaded with the fixed base 51 and mounted through a wall of the pivoting base 53. The head portion is engaged in the pivoting base 53, which restricts the maximum distance between the pivoting base 53 and the fixed base 51. In another embodiment, the shape of the movable component 52 is not limited thereto; for example, the movable component 52 may be a rod with a thread but without said head portion, or an elastic unit without a thread and thus providing the pulling force via resilience.

Consequently, the moving of the buckling ring unit 60 is controlled by the adjustment assembly 50, and the distance between the buckling ring unit 60 and the hook unit 10 is adjusted correspondingly. Thus the pulling force for the buckling ring unit 60 hooking on the buckling ring unit 60 is adjusted as well, which ensures the first locked object A and the second locked object B are sealed together by a suitable force.

For example, in this embodiment, after the head portion of the movable component 52 is rotated or an end of the threaded portion which is opposite the head portion is turned by a hex wrench, the threaded portion can be rotated with respect to the fixed base 51. When the movable component 52 and fixed base 51 are rotated with respect to each other, the movable component 52 can be moved with respect to the fixed base 51 easily. Precisely, the head portion of the movable component 52 can drive the pivoting base 53 and the buckling ring unit 60 to move, which adjusts the distance between the buckling ring unit 60 and the hook unit 10. When the distance between the buckling ring unit 60 and the hook unit 10 is changed, the pulling force that the buckling ring unit 60 pulls the hook unit 10 and the fixing unit 20 is changed correspondingly, so a tightening force provided by the adjustable buckle lock of the present invention and exerted on the first locked object A and the second locked object B can be adjusted. Therefore, the first locked object A and the second locked object B can be sealed together by a suitable force. In other words, if the first locked object A is a lid body of a freezer and the second locked object B is a main body of the freezer, the adjustable buckle lock of the present invention is capable of assisting preventing the cooled gas from leaking. Besides, the pulling force can be adjusted via turning the movable component 52, so the operation is fast and convenient. Further, the structure of the adjustment assembly 50 is very simple and easy to manufacture.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. An adjustable buckle lock configured to be mounted on a first locked object and a second locked object thereby securing the first locked object and the second locked object; the adjustable buckle lock comprising:
a hook unit configured to be securely mounted on the first locked object;
a fixing unit configured to be securely mounted on the second locked object;
a wrench unit, two ends of the wrench unit defined as:
a pivotal end pivotally mounted on the fixing unit; and
an operation end opposite the pivotal end;
an adjustment assembly mounted on the wrench unit; and
a buckling ring unit pivotally mounted on the adjustment assembly and selectively engaged with the hook unit;
wherein the adjustment assembly is capable of controlling a distance between the buckling ring unit and the hook unit.

2. The adjustable buckle lock as claimed in claim 1, wherein the adjustment assembly comprises:
a fixed base securely mounted on the wrench unit;
a movable component movably mounted on the fixed base; and
a pivoting base securely mounted on the movable component; the buckling ring unit pivotally mounted on the pivoting base.

3. The adjustable buckle lock as claimed in claim 2, wherein the fixed base is in a T-shape, two arm portions of the T-shape are securely mounted on the wrench unit, and the movable component is movably mounted on a leg portion of the T-shape.

4. The adjustable buckle lock as claimed in claim 2, wherein the pivoting base is tubular, an axial direction of the pivoting base is perpendicular to a moving direction of the movable component, and the buckling ring unit is rotatably mounted through the pivoting base.

5. The adjustable buckle lock as claimed in claim 3, wherein the pivoting base is tubular, an axial direction of the pivoting base is perpendicular to a moving direction of the movable component, and the buckling ring unit is rotatably mounted through the pivoting base.

6. The adjustable buckle lock as claimed in claim 4, wherein the movable component is a screw and comprises:
a threaded portion screwed on the fixed base and mounted through a wall of the tubular pivoting base; and
a head portion mounted in the tubular pivoting base.

7. The adjustable buckle lock as claimed in claim 5, wherein the movable component is a screw and comprises:
a threaded portion screwed on the fixed base and mounted through a wall of the tubular pivoting base; and
a head portion mounted in the tubular pivoting base.

8. The adjustable buckle lock as claimed in claim 4, wherein a sectional area of the pivoting base is C-shaped and the sectional area is perpendicular to the axial direction of the pivoting base.

9. The adjustable buckle lock as claimed in claim 7, wherein a sectional area of the pivoting base is C-shaped and the sectional area is perpendicular to the axial direction of the pivoting base.

10. The adjustable buckle lock as claimed in claim 8, wherein an opening of the C-shaped sectional area of the pivoting base is oriented away from the wrench unit.

11. The adjustable buckle lock as claimed in claim 9, wherein an opening of the C-shaped sectional area of the pivoting base is oriented away from the wrench unit.

12. The adjustable buckle lock as claimed in claim 2, wherein the movable component is threaded and screwed on the fixed base, and the pivoting base and the buckling ring unit are moveable by rotating the movable component.

13. The adjustable buckle lock as claimed in claim 11, wherein the movable component is threaded and screwed on the fixed base, and the pivoting base and the buckling ring unit are moveable by rotating the movable component.

14. The adjustable buckle lock as claimed in claim 1, wherein the wrench unit comprises:
two side walls parallel to and spaced apart from each other; and
two elongation grooves respectively formed on the side walls; an extending direction of each one of the elongation grooves parallel to a moving direction of the buckling ring unit as the buckling ring unit is moved by the adjustment assembly.

15. The adjustable buckle lock as claimed in claim 13, wherein the wrench unit comprises:
two side walls parallel to and spaced apart from each other; and
two elongation grooves respectively formed on the side walls; an extending direction of each one of the elongation grooves parallel to a moving direction of the buckling ring unit as the buckling ring unit is moved by the adjustment assembly.

16. The adjustable buckle lock as claimed in claim 1 further comprising:
an elastic unit, one end of the elastic unit securely mounted on the wrench unit, another end of the elastic unit securely mounted on the fixing unit, and thereby the elastic unit capable of rotating the wrench unit toward the fixing unit.

17. The adjustable buckle lock as claimed in claim 15 further comprising:
an elastic unit, one end of the elastic unit securely mounted on the wrench unit, another end of the elastic unit securely mounted on the fixing unit, and thereby the elastic unit capable of rotating the wrench unit toward the fixing unit.
